(19) United States
(12) Patent Application Publication
(10) Pub. No.: US 2021/0362902 A1
(43) Pub. Date: Nov. 25, 2021

(54) THREAD-BIASED CONTAINER PREFORM

(71) Applicant: NIAGARA BOTTLING, LLC, Diamond Bar, CA (US)

(72) Inventors: Jay Clarke Hanan, Glendora, CA (US); Ahmed Tasnub Takaddus, Riverside, CA (US)

(21) Appl. No.: 17/326,177

(22) Filed: May 20, 2021

Related U.S. Application Data
(60) Provisional application No. 63/027,877, filed on May 20, 2020.
(60) Provisional application No. 63/062,776, filed on Aug. 7, 2020.

(51) Int. Cl. B65D 1/02

(52) U.S. Cl. CPC B65D 1/0246

(57) ABSTRACT

A container preform for forming a plastic container includes a neck with a finish portion including an opening and one or more threads disposed on the finish portion for rotatably engaging with a closure to seal contents within an interior of a container formed from the preform. At least one of the one or more threads includes a main thread body, and a thread start configured to guide a thread of the closure into engagement with the main thread body. The thread start being biased towards the opening.

### CROSS-REFERENCE TO RELATED APPLICATION

The present application is related to and claims the priority benefit of U.S. Provisional Patent Application No. 63/027,877, filed on May 20, 2020, and U.S. Provisional Patent Application No. 63/062,776, filed on Aug. 7, 2020, the entire contents of each of which are hereby incorporated by reference.

### TECHNICAL FIELD

Embodiments of the present disclosure generally relate to the field of plastic bottles and preforms. More specifically, embodiments of the disclosure relate to a tamper evidence container preform that includes a thread-biased finish portion to facilitate installing a closure onto a container formed from the container preform.

### BACKGROUND

Plastic containers have been used as a replacement for glass or metal containers in thepackaging of beverages for several decades. The most common plastic used in making beveragecontainers today is polyethylene terephthalate (PET). Containers made of PET are transparent, thin walled, and have the ability to maintain their shape by withstanding the force exerted on the walls of the container by their contents. Advantages of PET containers include lighter weight and decreased breakage as compared to glass, and lower costs overall when taking both production and transportation into account. PET resins are also reasonably priced and easy to process. PET containers are generally made by a process that includes the blow-molding of plastic preforms which have been made by injection molding of the PET resin.

A PET container for storing liquid contents typically includes a base that extends up to a grip portion suitable for affixing a label, as well as providing a location for grasping the container. The grip portion generally transitions into a shoulder, which connects to a bell. The bell has a diameter that generally decreases as the bell extends upward from the shoulder to a neck and a finish portion. The finish portion is adapted to receive a closure, such as a bottle cap to seal the contents within the interior of the plastic container.

In many instances, the closure includes a tamper evidence band that is disposed around the perimeter of the finish portion. The tamper evidence band generally remains positioned on the finish portion when an end-user loosens the closure to access the contents within the container. As such, the tamper evidence band and the finish portion cooperate to indicate to the end-user whether or not the closure has been previously loosened after being installed by the manufacturer.

One difficulty that may be encountered when working with relatively light plastic containers, such as PET containers, is optimally tightening a closure onto the finish portion of the containers after the containers are filled with liquid contents. On one hand, if the closure is under-tightened, the container may be left unsealed and the liquid contents may leak out of the container. On the other hand, if the closure is over-tightened, the closure and the finish portion may be damaged, again allowing the liquid contents to leak out of the container.

Another difficulty during closure installation is properly engaging threads of the closure with threads disposed on the finish portion. Cross-threading and/or damaging threads on the closure and the finish portion may occur when threads on the closure are not optimally aligned with threads on the finish portion before rotating the closure onto the finish portion. Cross-threading and/or damaged threads are known to leave containers unsealed and allow the liquid contents to leak out of the containers. As such, there is a need for equipment capable of installing closures onto containers, such that contents are sealed therein, without damaging threads disposed around the finish portion or the closure during the installation process. Embodiments disclosed herein provide container preforms that include biased or buttressed threads configured to assist equipment installing closures onto containers formed from the preforms.

### SUMMARY

The disclosure provides, in one aspect, a container preform for forming a plastic container. The preform comprising a neck with a finish portion including an opening and one or more threads disposed on the finish portion for rotatably engaging with a closure to seal contents within an interior of a container formed from the preform. At least one of the one or more threads includes a main thread body, and a thread start configured to guide a thread of the closure into engagement with the main thread body. The thread start being biased towards the opening.

In some aspects, a first thread pitch between the thread start and an adjacent thread is greater than a second thread pitch between the main thread body and the adjacent thread. In some aspects, the main thread body is skewed away from the opening. In some aspects, the main thread body includes a first profile and the thread start includes a second profile that is different than the first profile. In some aspect, the preform further comprising a transition region extending between the main thread body and the thread start to transition the first profile of the main thread body to the second profile of the thread start. In some aspects, the at least one of the one or more threads includes a rounded crest joined with a sidewall of the finish portion by way of concave flanks. In some aspect, each of the concave flanks has a uniform width along the main thread body. In some aspects, the thread start includes a flank width proximal the opening that is narrower than an opposing flank width distal from the opening. In some aspects, at least one of the thread start or the main thread body includes a cross-sectional contour having a first surface, a second surface, a planar angled surface transitioning from one of the first or second surfaces, and a crest extending between the other one of the first or second surface and the planar angled surface. In some aspects, the crest of the thread start is positioned closer to the opening than the crest of the main thread body.

The disclosure provides, in another aspect, a finish portion assembly of a container preform for forming a plastic container. The finish portion assembly comprising a neck with a finish portion having an opening and including a first set of threads, and a closure including a second set of threads for engaging with the first set of threads to seal contents within an interior of a container formed from the preform. At least one thread of one of the first or second set of threads includes a main thread body, and a thread start configured to guide the other of the first or second set of threads into engagement with the one of the first or second set of threads. A first thread pitch between the thread start and an adjacent thread is greater than a second thread pitch between the main thread body and the adjacent thread.

In some aspects, the thread start of the first set of threads is biased towards the opening. In some aspects, the thread start of the second set of threads is biased away from the opening. In some aspects, the first set of threads includes a rounded crest joined with a sidewall of the finish portion by way of a first pair of opposing flanks and the second set of threads includes a rounded crest joined with a sidewall of the closure by way of a second pair of opposing flanks, and wherein with respect to at least one of the first pair of opposing flanks and the second pair of opposing flanks, a flank width of one flank of the opposing flanks is narrower than a flank width of the other flank of the opposing flanks.

The disclosure provides, in another aspect, a finish portion of a container preform for forming a plastic container. The finish portion comprising one or more threads disposed on the finish portion for rotatably engaging with a closure. At least one of the one or more threads includes a main thread body having a first profile, and a thread start configured to guide a thread of the closure into engagement with the main thread body. The thread start having a second profile that is different than the first profile.

In some aspects, the finish portion further comprising a transition region extending between the main thread body and the thread start to transition the first profile of the main thread body to the second profile of the thread start. In some aspects, finish portion includes an opening, and wherein the thread start is biased towards the opening. In some aspects, a first thread pitch between the thread start and an adjacent thread is greater than a second thread pitch between the main thread body of the adjacent thread. In some aspects, the first profile is defined as a cross-sectional contour of the main thread body in a first circumferential position normal to the finish portion and the second profile is defined as a cross-sectional contour of the thread start in a second circumferential position normal to the finish portion. In some aspects, at least one of the first profile or the second profile includes a first surface, a second surface, a planar angled surface transitioning from one of the first or second surfaces, and a crest extending between the other one of the first or second surface and the planar angled surface.

Other aspects of the disclosure will become apparent by consideration of the detailed description and accompanying drawings.

### BRIEF DESCRIPTION OF THE DRAWINGS

The drawings refer to embodiments of the present disclosure in which:

FIG. 1 illustrates a side view of an exemplary container suitable for storing pressurized contents.

FIG. 2 illustrates a side plan view of an exemplary embodiment of a preform suitable for being blow-molded to form a container in accordance with the present disclosure.

FIG. 3 illustrates a cross-sectional view of the preform of FIG. 2, taken a long midline of the preform.

FIG. 4 illustrates a close-up cross-sectional view of a sidewall portion of a finish portion comprising the preform illustrated in FIG. 2.

FIG. 5 illustrates a close-up plan view of a thread start disposed on the container preform of FIG. 2, showing that a thread start that is oriented towards a top of a finish portion comprising the container preform.

FIG. 6 illustrates a cross-sectional view of a thread disposed on the preform of FIG. 2, taken along line 6-6 of FIG. 5.

FIG. 7 illustrates a cross-sectional view of a top-biased thread disposed on the preform of FIG. 2, taken along line 7-7 of FIG. 5.

FIG. 8A is a perspective isolated view of a thread of the preform of FIG. 2, illustrating a transition portion between the thread start and a main thread body of the thread.

FIG. 8B is a partial perspective view of the preform of FIG. 2, illustrating the thread start and a thread end of the threads.

FIG. 8C is another partial perspective view of the preform of FIG. 2, illustrating the thread start and a thread end of the threads.

FIG. 8D is a partial side view of the preform of FIG. 2, illustrating the thread start and a thread end of the threads.

FIG. 9 illustrates a side plan view of an exemplary embodiment of a container closure that may be threadably engaged with a finish portion of a container.

FIG. 10 illustrates a cross-sectional view of the container closure of FIG. 9, taken along line 10-10 in accordance with the present disclosure.

FIG. 11 illustrates a side plan view of another exemplary embodiment of container preform that includes threads that are biased toward a top of the preform to guide installation of a closure onto a container formed from the container preform.

FIG. 12 illustrates a close-up profile view of a thread start disposed on the container preform of FIG. 8, showing that the thread start is oriented towards a top of a finish portion comprising the container preform.

FIG. 13 illustrates a close-up plan view of the thread start of FIG. 9 and a neighboring thread comprising the finish portion of the container preform of FIG. 8.

While the present disclosure is subject to various modifications and alternative forms, specific embodiments thereof have been shown by way of example in the drawings and will herein be described in detail. The disclosure should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to oneof ordinary skill in the art that the embodiments disclosed herein may be practiced without these specific details. In other instances, specific numeric references such as “first container,” may bemade. However, the specific numeric reference should not be interpreted as a literal sequential order but rather interpreted that the “first container” is different than a “second container.” Thus,the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, there is a continuous interest in creating the lightest possible plastic container so as to maximize cost savings in both transportation and manufacturing by making and using containers that contain less plastic. One difficulty often encountered when working with relatively light plastic containers is optimally installing a closure onto a finish portion of the containers after the containers are filled with liquid contents. Cross-threading and/or damaging threads on the closure and the finish portion may occur when threads on the closure are not optimally aligned with the threads on the finish portion before rotating the closure onto the finishportion, thus causing the containers to remain unsealed and leak contents. Embodiments disclosed herein provide container preforms that include threads that are biased toward a top of the finish portion to guide engaging threads of the closure with threads of the finish portion during installation of a closure onto a container formed from the container preform.

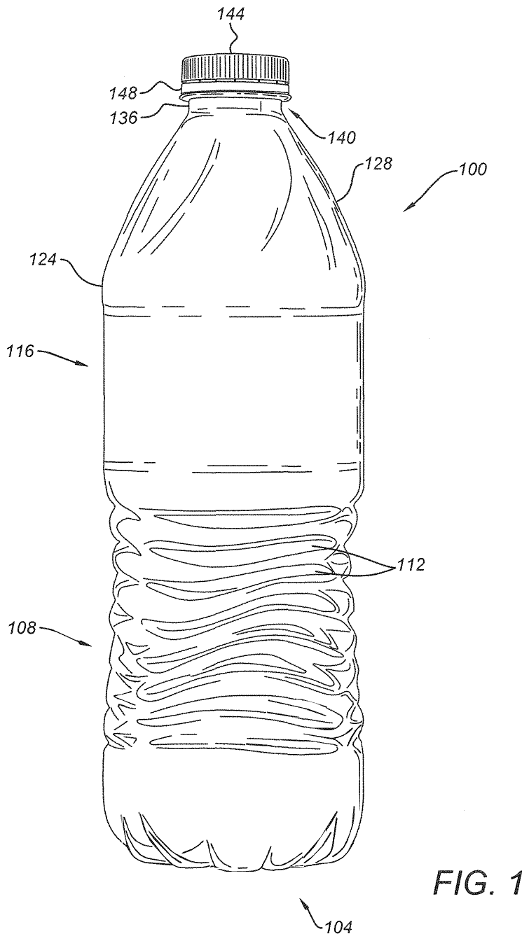

FIG. 1 illustrates a side view of an exemplary container 100 typically used for storing liquid contents, such as water, juice, and particularly carbonated contents. The container 100 comprises a base 104 that extends up to a grip portion 108. In some embodiments, the base 104 may be of the petaloid variety, although other configurations of the base may be incorporated into the container 100, without limitation. The grip portion 108 comprises a plurality of grip portion ribs 112 (i.e., sidewall ribs). As illustrated in FIG. 1, the plurality of grip portion ribs 112 generally vary in depth, and swirl or angulate around the grip portion 108. A label portion 116 is connected to the grip portion 108 and comprises one or more label panel ribs (not shown). The label panel portion 116 transitions into a shoulder 124, which connects to a bell 128.

In the embodiment illustrated in FIG. 1, the bell 128 comprises a plurality of design features 132. In other embodiments, however, the bell 128 may include various other design features, or may be smooth and generally unornamented. The bell 128 connects to a neck 136, which connects to a finish portion 140. As shown in FIG. 1, the bell 128 comprises a diameter that generally decreases as the bell 128 extends upward from the shoulder 124 to the neck 136 and the finish portion 140. The finish portion 140 is adapted to receive a closure, such as by way of non-limiting example, a container cap or closure 144, so as to seal contents within the container 100. The finish portion 140 generally defines an opening that leads to an interior of thecontainer 100 for containing a beverage, or other contents, such as any of a variety of carbonated soft drinks. The finish portion 140 may be of a Carbonated Soft Drink (CSD) variety or may be configured to receive closures suitable for sealing noncarbonated contents within the interior of the container 100. Further, in some embodiments, the finish portion 140 may be configured to retain hot-filled contents with the container or may be configured to retain a gas, such as nitrogengas (N2) within the interior of the container, without limitation.

As shown in FIG. 1, a tamper evidence closure 144, such as a bottle cap, may be threadably engaged with the finish portion 140. The closure 144 generally includes interior threads that are configured to engage with threads disposed on the finish portion 140, as described herein. During tightening of the closure 144 onto the finish portion 140, a plug seal of the closure 144 extends into the opening of the container 100 and enters into a pressed relationship with the finish portion 140 whereby contents may be sealed in the interior of the container 100.

With continuing reference to FIG. 1, the closure 144 includes a tamper evidence band 148 to provide an indication of whether or not the closure 144 has been loosened after being installed by a manufacturer. In some embodiments, the tamper evidence band 148 may be attached to the closure 144 by a multiplicity of thin connections. The tamper evidence band 148 may include a cam that is configured to fixedly engage with a tamper evidence ledge disposed on the finish portion 140 during loosening of the closure 144. Once the closure 144 is installed ontothe finish portion 140 by a manufacturer and later an end-user loosens the closure 144, the cam engages the tamper evidence ledge, breaking the thin connections between tamper evidence band 148 and the closure 144. The tamper evidence band 148 remains positioned on the tamper evidence ledge after the closure 144 is removed from the container 100. As such, the tamper evidence band 148 cooperates with the tamper evidence ledge to indicate to the end-user whether or not the closure 144 has been previously loosened after being installed by the manufacturer.

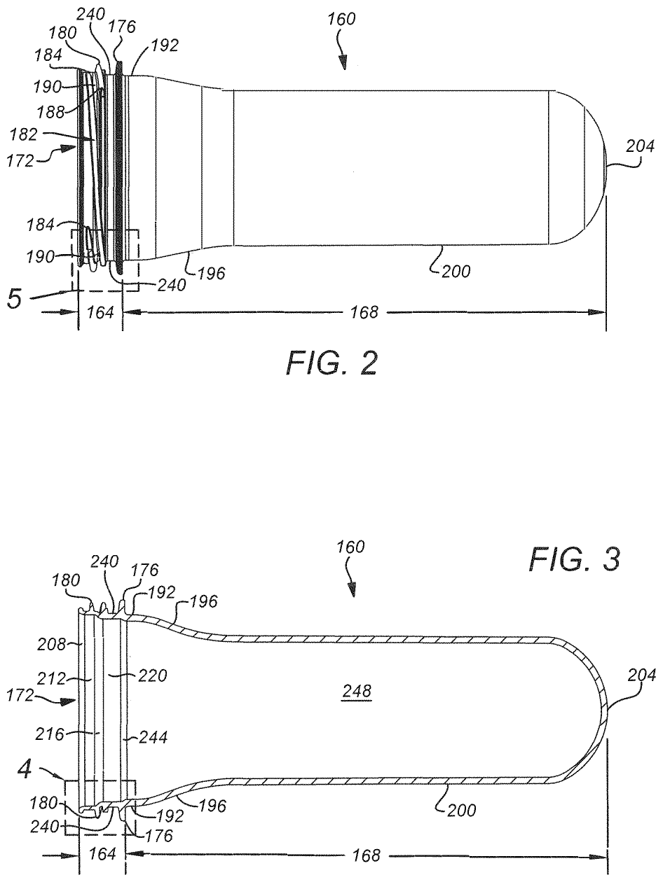

FIG. 2 illustrates an exemplary embodiment of a preform 160 suitable for being blow-molded to form a plastic bottle, such as the container 100, according to the present disclosure. The preform 160 preferably is made of material approved for contact with food and beverages such as virgin PET or recycled PET and can be of any of a wide variety of shapes and sizes. The preform 160 shown in FIG. 2 is of the type which will form a 12-16 oz. beverage bottle, but as will be understood by those skilled in the art, other preform configurations may be used depending upon the desired configuration, characteristics and use of the final article. The preform 160 may be made by injection molding methods, without limitation.

The preform 160 includes a finish portion 164 and a body portion 168, formed monolithically (i.e., as a single, or unitary, structure). Advantageously, the monolithic arrangement of the preform 160, when blow-molded into a bottle, provides greater dimensional stability and improved physical properties in comparison to a preform constructed of separate neck and body portions that are bonded together.

The finish portion 164 begins at an opening 172 to an interior of the preform 160 and extends to and includes a tamper evidence ledge 176. The finish portion 164 is further characterized by the presence of one or more threads 180 configured to provide a means to fastena cap, such as the closure 144 of FIG. 1, to the bottle produced from the preform 160. As such, the threads 180 are configured to rotatably engage with similar threads disposed within the closure 144 to provide a way to seal contents within the bottle. In the embodiment illustrated in FIG. 2, each of the threads 180 generally extends along a section of the circumference of the finish portion 164 and approaches the tamper evidence ledge 176. Thus, when the threads of the closure 144 are engaged with the threads 180, and the closure 144 is rotated in a clockwise direction, the closure 144 advances toward the tamper evidence ledge 176.

With reference to FIGS. 2 and 5, each of the one or more threads 180 begins at a thread start 184 and includes a main thread body 182 that extends along an angular section of the finish portion 164 to a thread end 188. The threads 180 each include a buttressed construction such that the thread start 184 includes a first construction or profile and the rest of the thread 180 (e.g., the main body 182) includes a second construction or profile. In the illustrated embodiment, the profiles are defined as a cross-sectional contour of threads 180 normal to the finish portion 164. For example, the first profile is defined as a cross-sectional contour of the main thread body in a first circumferential position normal to the finish portion 164 (e.g., at line 6-6) and the second profile is defined as a cross-sectional contour of the thread start in a second circumferential position normal to the finish portion 164 (e.g., at line 7-7). It should be appreciated that the term buttressed construction may encompass a thread with two or more profiles or constructions and is not limited to two profiles or constructions. More specifically, the profile or construction of any one or more of the threads 180 is asymmetric, e.g., asymmetric in shape, contour, cross section, geometry, or material distribution, in one or more portions along the thread such that, as an example, the thread start 184 profile is different than the main body 182 profile of the thread 180. The thread start 184 is configured to guide a corresponding thread groove of the closure 144 into a space, or a valley 190, between adjacent threads 180 so as to threadably engage the closure 144 with the finish portion 164. Further, the threads 180 generally are disposed adjacently to one another, separated by valleys 190, and are spaced uniformly around the circumference of the finish portion 164.

The preform 160 may include three threads 180 disposed around the finish portion 164 such that the thread starts 184 of adjacent threads 180 are spaced at substantially 120-degree intervals around the perimeter of the finish portion 164. As will be appreciated, however, more or fewer than three threads 180 may be incorporated into the finish portion 164 without deviating beyond the scope of the present disclosure.

In some embodiments, a plurality of gaps (not shown) may be disposed in the threads 180 and positioned uniformly around the perimeter of the finish portion 164. Preferably, the gaps of adjacent threads 180 are vertically aligned so as to form channels extending longitudinally along the finish portion 164. The channels advantageously operate to relieve pressure within the container 100 when the closure 144 is loosened. As will be appreciated, the channels may provide a direct route for gases escaping the interior of the container 100, rather than the gases being forced to travel around the finish portion 164 between adjacent threads 180.

The body portion 168 includes a neck portion 192 that extends to a tapered portion 196 of the body portion 168. The tapered portion 196 comprises a smooth transition from a diameter of the neck portion 192 to a relatively smaller diameter of a cylindrical portion 200 of the preform 160. The cylindrical portion 200 is a generally elongate member that culminates in an end cap 204. In some embodiments the body portion 168 may be generally cylindrical, and the end cap 204 may be conical or frustoconical and may also be hemispherical, and the very terminus of the end cap 204 may be flattened or rounded.

In some embodiments, a wall thickness of the cylindrical portion 200 may be substantially uniform throughout the cylindrical portion 200 and the end cap 204. A wall thickness of the tapered portion 196, however, generally decreases from the wall thickness of the cylindrical portion 200 to a relatively thinner wall thickness of the neck portion 192. As will beappreciated, the wall thickness of the cylindrical portion 200 is relatively greater than the wall thickness of the neck portion 192 so as to provide a wall thickness at the desired dimensions of afinished product after the preform 160 is blow-molded into the shape and size of a bottle. As such, the wall thickness throughout most of the body portion 168 will depend upon the overall size of the preform 160 and the wall thickness and overall size of the resulting container.

FIG. 3 illustrates a cross-sectional view of the preform 160 illustrated in FIG. 2, taken along a midline of the preform 160. As will be appreciated, the finish portion 164 comprises a cylindrical body that begins at the opening 172 to the interior of the container 100 and extends to and includes the tamper evidence ledge 176. The finish portion 164 includes a bevel 208 disposed at the beginning of the opening 172. The bevel 208 is configured to enter into sliding contact with a plug seal of the closure 144 so as to prevent contents from leaking out of the container 100 formed from the preform 160. In some embodiments, the bevel 208 operates to guide the plug seal onto a sealing surface 212 disposed on an interior of the finish portion 164. In general, the bevel 208 and the sealing surface 212 comprise portions of the interior of the finish portion 164 that extend circumferentially around the opening 172.

As will be appreciated, the sealing surface 212 must comprise a sufficiently smooth surface capable of cooperating with the plug seal to retain contents under pressure, such as carbonated contents, within the container 100. To this end, it is contemplated that the sealing surface 212 may be highly polished so as to be substantially free of surface defects and thus conditioned to form a tight seal with the plug seal of the closure 144. Preferably, the sealing surface 212 is to be polished to a degree of smoothness that is commonly associated with a mirror finish. As such, it is contemplated that the sealing surface 212 comprises a mirror polished region along the interior of the finish portion 164. Further, in some embodiments, the bevel 208 may also be conditioned to comprise a mirror polished region at the beginning of the opening 172. Any of various techniques may be used to mirror polish either or both of the sealing surface 212 and the bevel 208, without limitation.

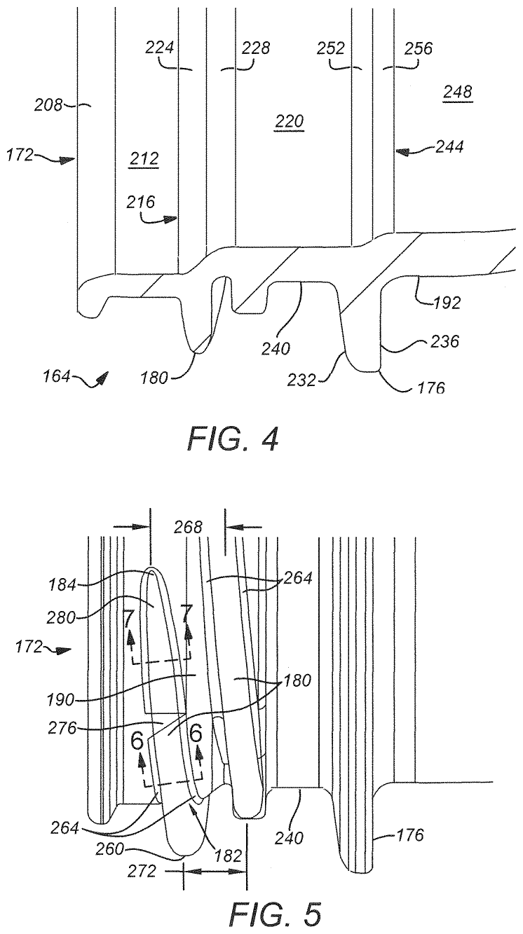

As shown in FIG. 3, the sealing surface 212 extends away from the bevel 208, deeper into the opening 172 to a transition surface 216. The transition surface 216 comprises a region within the interior of the finish portion 164 wherein the interior diameter of the opening 172 generally narrows from the diameter of the sealing surface 212 to a smaller diameter of a handling surface 220. As best shown in FIG. 4, the transition surface 216 comprises a reverse curve surface that includes a concave portion 224 that extends from the sealing surface 212 and joins with a convex portion 228 that extends to the handling surface 220. As will be recognized,the handling surface 220 includes a diameter of the opening 172 that is configured to receive various forms of equipment used to configure the preform 160 into the container 100.

It is contemplated that the transition surface 216 is to be capable of cooperating with the plug seal of the closure 144 to form a tight seal between the closure 144 and the container 100. In some embodiments, the concave portion 224 may be configured to forcibly receive an end of the plug seal so as to form a tight seal therebetween. Further, in some embodiments, the convex portion 228 may be configured to forcibly receive the end of the plug seal. As such, the transition surface 216 may include a smooth surface that is polished similarly to the sealing surface 212. It is envisioned that the transition surface 216 may be mirror polished, as describedhereinabove with respect to the sealing surface 212.

Moreover, in some embodiments, the plug seal of the closure 144 may be configured to extend into the opening 172 such that the plug seal cooperates with the handling surface 220 to seal the container 100. In such embodiments, the plug seal may include a sidewall shape that mates with the concave and convex portions 224, 228. As will be appreciated, therefore, the handling surface 220 may be mirror polished similarly to the sealing surface 212 and the transition surface 216. It is contemplated that mirror polished surface may be achieved by way of any of various suitable polishing techniques, such as mechanical machining and buffing, chemical treatments, plasma treatments, and the like, without limitation.

Now with reference to FIG. 4, the tamper evidence ledge 176 comprises a rounded upper portion 232 and a substantially flat lower portion 236. As will be appreciated, the rounded upper portion 232 facilitates passing the tamper evidence band 148 of the closure 144 over the tamper evidence ledge 176 during assembly of the closure 144 onto the container 100. The flat lower portion 236 is configured to retain the tamper evidence band 148 positioned below the tamper evidence ledge 176 during loosening of the closure 144. For example, when the closure 144 is initially installed onto the container 100 by a manufacturer, the tamper evidence band 148 easily passes over the tamper evidence ledge 176 due to the rounded upper portion 232. When an end-user later loosens the closure 144, the flat lower portion 236 retains the tamper evidence band 148 below the tamper evidence ledge 176, causing the tamper evidence band 148 to break loose from the closure 144. Thus, the flat lower portion 236 of the tamper evidence ledge 176 and the tamper evidence band 148 of the closure 144 cooperate to indicate to the end-user that the closure 144 has not been previously loosened after being installed by the manufacturer. It should be understood, however, that the tamper evidence ledge 176 is not limited to being coupled with tamper evidence bands, as described above, but rather the tamper evidence ledge 176 may be configured to operate with any of various devices for indicating whether or not the container has been previously opened. In some embodiments, the preform 160 may be devoid of a tamper evidence ledge.

In some embodiments, such as the illustrated embodiment of FIGS. 3-4, a secondary transition surface 244 may be disposed between the handling surface 220 and an interior surface 248 of the body portion 168. In general, the secondary transition surface 244 comprises a region within the interior of the finish portion 164 wherein the interior diameter of the opening 172 narrows from the diameter of the handling surface 220 to a smaller diameter of the interior surface 248. As shown in FIG. 4, the secondary transition surface 244 comprises a reverse curve surface that includes a concave portion 252 that extends from the handling surface 220 to a convex portion 256 that extends to the interior surface 248.

In some embodiments, the secondary transition surface 244 may be configured to cooperate with the plug seal of the closure 144 to form a tight seal between the closure 144 and the container 100 suitable for storing pressurized contents, such as carbonated beverages, withinthe container 100. As such, the concave portion 252 may be configured to tightly receive an endof the plug seal to form a tight seal therebetween. In some embodiments, the convex portion 256 may be configured to forcibly receive and compress the end of the plug seal. To this end, the secondary transition surface 244 may include a smooth surface that is polished similarly to the sealing surface 212. It is envisioned that the secondary transition surface 244 may be mirror polished, as described hereinabove with respect to the sealing surface 212.

In some embodiments, the plug seal of the closure 144 may be configured to extend into the opening 172 such that the plug seal extends beyond the secondary transition surface 244and thus cooperates with the portion of the interior surface 248 near the convex portion 256. In some embodiments, the interior surface 248 may have a diameter that tightly compresses the endof the plug seal to seal the pressurized contents within the container 100. It is contemplated that,in some embodiments, the plug seal may include a sidewall profile that mates with the concave and convex portions 252, 256. As such, the interior surface 248 preferably is mirror polished similarly to the mirror polish of the sealing surface 212. As disclosed hereinabove, the mirror polished surface may be achieved by way of any of various suitable polishing techniques, such asmechanical machining and buffing, chemical treatments, plasma treatments, and the like, withoutlimitation.

In the embodiment illustrated in FIG. 3, the surfaces 212, 220, 248 generally comprisea stepped interior of the finish portion 164. As such, the stepped interior comprises a graduated narrowing of the opening 172 that extends from the bevel 208, through the finish portion 164, tothe tamper evidence ledge 176. It is contemplated that the stepped interior comprises multiple sidewall portions of the finish portion 164 that may be configured to advantageously minimize the quantity of resin comprising the finish portion 164, as compared to finish portions comprising a substantially uniform diameter.

In some embodiments, the stepped interior may be configured to compressibly receive a plug seal of the closure 144 that comprises graduated seals configured to tightly engagewith the graduated narrowing of the opening 172. For example, the stepped interior can include one or more sealing surfaces that are each configured to tightly engage with one of the graduated seals of the plug seal to contribute to forming a tight seal between the closure 144 and the container 100. As will be appreciated, therefore, the graduated seals of the plug seal generally include diameters that are suitable for engaging with the graduated narrowing of the opening 172 so as to seal pressurized contents, such as carbonated beverages, within the container 100. It is contemplated that the one or more sealing surfaces comprise mirror-polished surfaces that are joined together by transition surfaces. Further, the transition surfaces 216, 244 are contemplatedto comprise mirror-polished surfaces that cooperate with the one or more seals of the plug seal so as to contribute to forming the tight seal between the closure 144 and the container 100.

In the exemplary embodiment shown in FIG. 3, the sealing surface 212 is configured to compressibly receive a first seal comprising the plug seal, and the handling surface 220 is configured to compressibly receive a second seal of the plug seal. Further, the interior surface 248 may be configured to compressibly receive a third seal comprising the plug seal. According, the sealing surface 212 includes a first diameter configured to tightly compress the first seal of the plug seal, and the handling surface 220 includes a second diameter configured to tightly compress the second seal. The interior surface 248 includes a third diameter configured to tightly compress the third seal of the plug seal. As will be appreciated, the third diameter is equal to or less than the second diameter, and the second diameter is equal to or less than the first diameter. Further, the transition surface 216 comprises a change in diameter of the opening 172 that transitions from the first diameter of the sealing surface 212 to the second diameter of the handling surface 220. The secondary transition surface 244 comprises a change diameter of the opening 172 that transitions from second diameter of the handling surface 220 to the third diameter of the interior surface 248. As disclosed herein above, the transition surfaces 216,244 comprise mirror-polished surfaces that may be formed by way of any of various suitable polishing techniques. configured to operate with any of various devices for indicating whether or not the container has been previously opened.

Disposed between the tamper evidence ledge 176 and the threads 180 is a handling valley 240 that extends circumferentially around the finish portion 164. The handling valley 240 comprises a portion of the finish portion 164 that has a wall thickness and a diameter that are substantially similar to the wall thickness and diameter of the neck portion 192, below the tamper evidence ledge 176. As such, the handling valley 240 and the neck portion 192 advantageously enable gripping fingers to engage with and support the container 100 during air-conveying the container 100 along a manufacturing assembly. For example, a first pair of gripping fingers canextend into the handling valley 240 to support the container 100 at a first station of a manufacturing line. Then, upon being conveyed to a second station, a second pair of gripping fingers can extend around the neck portion 192, below the tamper evidence ledge 176, while the first pair of gripping fingers are removed from the handling valley 240. Similarly, upon arriving at a third station, a third pair of gripping fingers can engage with the handling valley 240 while the second pair of gripping fingers are removed from the neck portion 192. Thus, the container 100 can be transported along the manufacturing line by alternatively engaging gripping fingers with the handling valley 240 and the neck portion 192.

As will be appreciated, the handling valley 240 provides a separation between the tamper evidence ledge 176 and the threads 180 suitable for receiving the pair of gripping fingers, as described above. In general, the separation must be large enough to allow the gripping fingersto easily pass between the tamper evidence ledge 176 and the threads 180. As such, any of various separations, greater than the width of the gripping fingers, may be disposed between the tamper evidence ledge 176 and the threads 180, without limitation and without deviating beyondthe scope of the present disclosure.

As described herein, once the preform 160 has been blow-molded to form the container 100 and then the container 100 has been filled with liquid contents, the closure 144 is installed onto the finish portion 164, by way of suitable equipment, to seal the contents in the interior of the container 100. In general, the threads 180 disposed around the finish portion 164 are engaged with thread grooves or valleys formed on the closure 144. The closure 144 is then rotated in a clockwise direction to advance the closure 144 toward the tamper evidence ledge 176. The closure 144 preferably is tightened until the tamper evidence band 148 is pushed over the tamper evidence ledge 176 and a plug seal comprising the closure 144 extends into the opening 172 of the finish portion 164, thereby sealing the liquid contents within the container 100.

In an assembly-line environment, a multiplicity of containers 100 are filled with liquid contents and sealed by closures 144 as the containers 100 are conveyed along the assembly-line. Each closure 144 must be optimally threaded and tightened onto the finish portion 164 of the container 100. If the closure 144 is under-tightened, the container 100 may be left unsealed and the liquid contents may leak out of the container 100. Alternatively, if the closure 144 is over-tightened, the closure 144 and the finish portion 164 may be damaged, againallowing the liquid contents to leak out of the containers 100. Moreover, if the threads of the closure 144 are improperly engaged with the threads 180, cross-threading and/or damaging of the threads 180 and the threads of the closure 144 may result, leading again to unsealed containers that may leak. In general, closures 144 must be optimally threaded and tightened onto finish portions 164 of the containers 100 by way of suitable installation equipment.

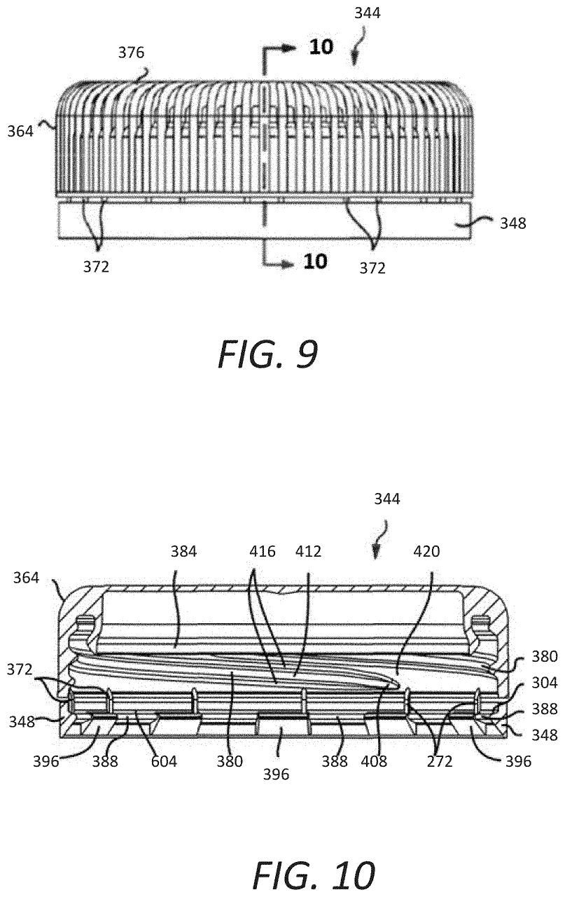

In the illustrated embodiment, the threads 180 formed on the finish portion 164 of the preform 160 have an asymmetric or buttressed construction, while the closure 144 includes a standard or uniform thread profile. In some embodiments, where finish portion 164 includes multiple threads 180 (e.g., three in the illustrated embodiment), one or more of the threads 180 may have an asymmetric or buttressed construction, while the remaining threads include a standard or uniform thread profile. In other embodiments, as described in more detail below and shown in FIGS. 9 and 10, the closure 144 may include one or more threads that also include an asymmetric or buttressed construction. In yet another embodiment, one of the closure 144 or the preform 160 may include the asymmetric or buttressed construction in one or more of the threads, while the other of the closure 144 or preform 160 may include a standard or uniform construction in one or more of the threads. Further, in an embodiment in which the closure 144 and the preform 160 have an asymmetric or buttressed construction, the asymmetry need not necessarily be identical therebetween. As such, it should be appreciated, that the disclosed embodiments herein related to the threads 180 may be applied equally to either the preform 160 or the closure 144.

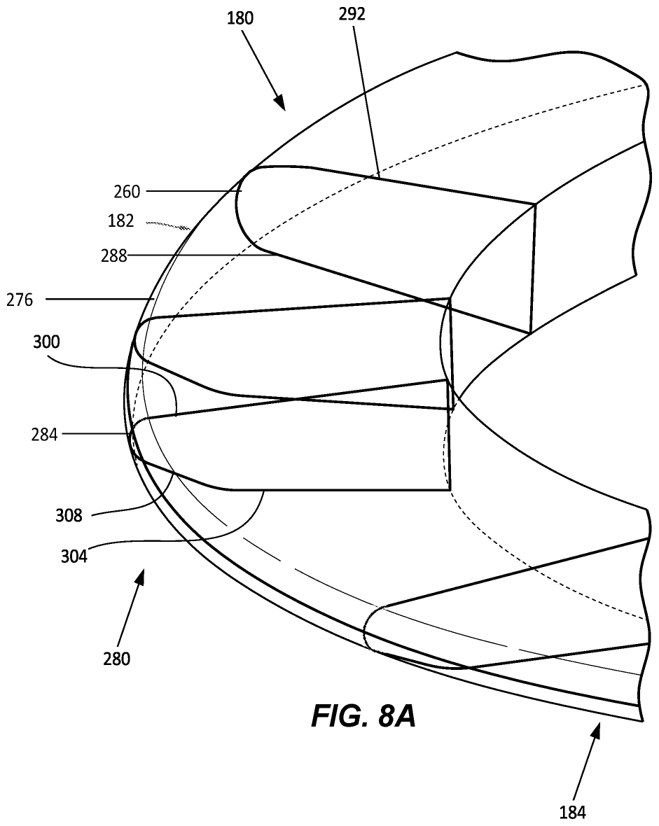

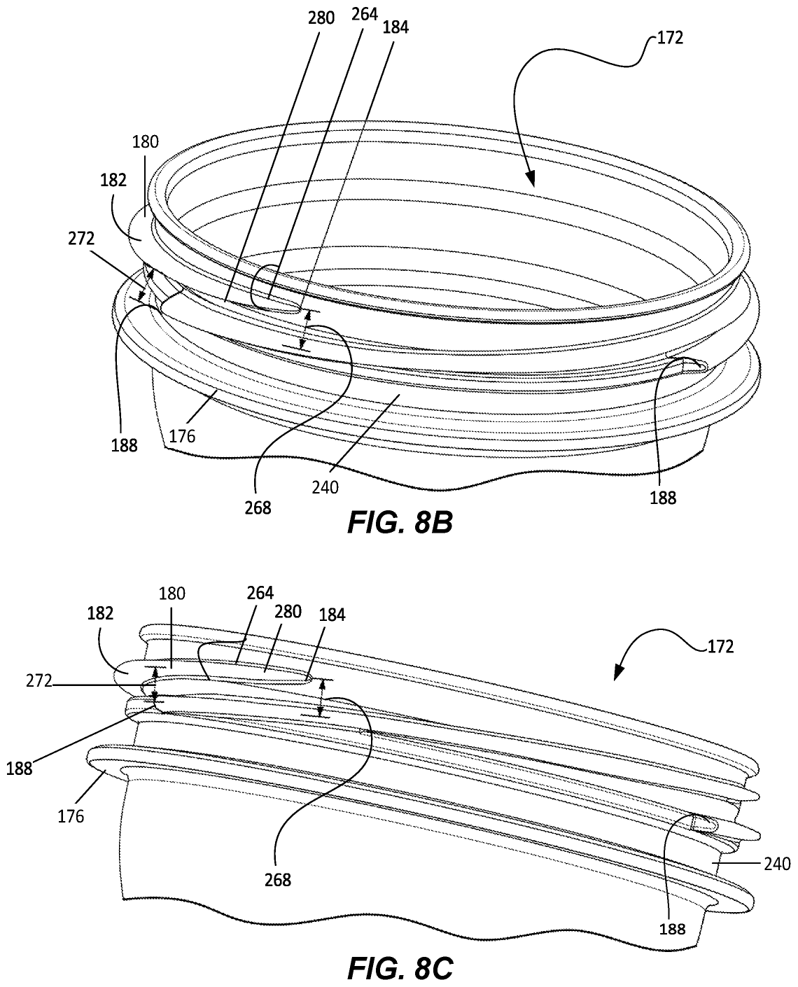

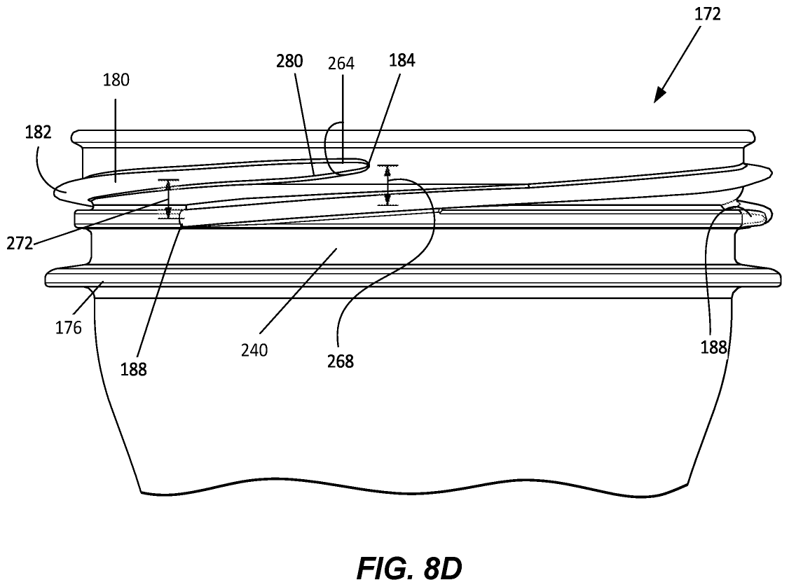

As shown in FIGS. 5 and 8A-8C, the threads 180 each include a first portion defining the thread start 184 and a second portion defining the main body 182 of the thread 180. The thread start 184 may include a tapered profile that gradually increases in width and thickness as the thread transitions to the main body 182. The thread starts 184 are configured to guide the threads of the closure 144 into the valleys 190 between the threads 180 of the finish portion 164. One or more of the threads 180 may include a buttressed or asymmetrical construction such that the thread start 184 may be skewed, biased, or angled toward the opening 172, while the main body 182 is skewed toward the tamper evidence ledge 176 or away from the opening 172. In other embodiments, the main body 182 of one or more of the threads 180 may transition to a neutral position in which the main body 182 is neither skewed toward nor away from the opening 172. In other words, the thread starts 184 form a thread biased connection, which reduces potential damaging or cross-threading of the threads 180 during installation of the closure 144. Skewing the thread starts 184 toward the opening 172 will result in a start pitch 268 greater than the thread pitch 272 between the main body 182 of the threads 180.

As best shown in FIGS. 5 and 8B-8C, each of the threads 180 generally includes a rounded crest 260 joined with the sidewall of the finish portion 164 by way of concave flanks 264. The flanks 264 may be formed as a fillet that extends from one or more of the threads 180. The flanks 264 include a relatively uniform width along a majority of the length of the threads 180 (e.g., the main body 182). Along the thread start 184, however, the width of the flank 264 nearest the opening 172 may be narrower that the width of the flank 264 facing away or farthest from the opening 172. Additionally, or alternatively, the flanks 264 may have alternative constructions or profiles, so the thread start 184 is angled or skewed towards the opening 172. As such, the flanks 264 may promote the thread start 184 to be oriented, angled, skewed, or biased, towards the opening 172 of the preform 160, such that a start pitch 268 disposed between the thread start 184 and the nearest neighboring thread 180 generally is greater than a thread pitch 272 disposed between the main body 182 of the adjacent threads 180. In other words, a first or start thread pitch 272 between the thread start 184 and an adjacent thread 180 is greater than a second thread pitch 272 between the main thread body 182 and the adjacent thread 180.

As described herein, the illustrated embodiment of the threads 180 and the thread start 184 includes crests 260 that are rounded and joined with adjacent concave flanks 264. It is contemplated, however, that the threads 180 and the thread starts 184 need not be limited to rounded crests 260 or concave flanks 264. For example, in some embodiments, the thread starts 184 may be buttressed toward the opening 172. Further, in some embodiments, the main body of the threads 180 may be buttressed toward the tamper evidence ledge 176 while the thread starts 184 are buttressed toward the opening 172. As will be appreciated, buttressing the thread starts 184 toward the opening 172 provides a start pitch 268 that is greater than the thread pitch 272 between the threads 180. Moreover, it should be understood that the threads 180 and/or the threads starts 184 may include any of various suitable thread profiles, or “thread forms,” in lieu of the rounded crests 260 and concave flanks 264. For example, in some embodiments, the threads 180 and/or the threads starts 184 may include metric threads, unified threads, square threads, ACME threads, buttress threads, knuckle threads, Whitworth threads, straight threads, tapered threads, aswell as any combination thereof, without limitation. Further, it is contemplated that the threads 180 and/or the threads starts 184 may be implemented in accordance with any of various suitable standards, such as, for example, any of various standards put forth by the Glass Packaging Institute (GPI) and the Society of the Plastics Industry (SPI).

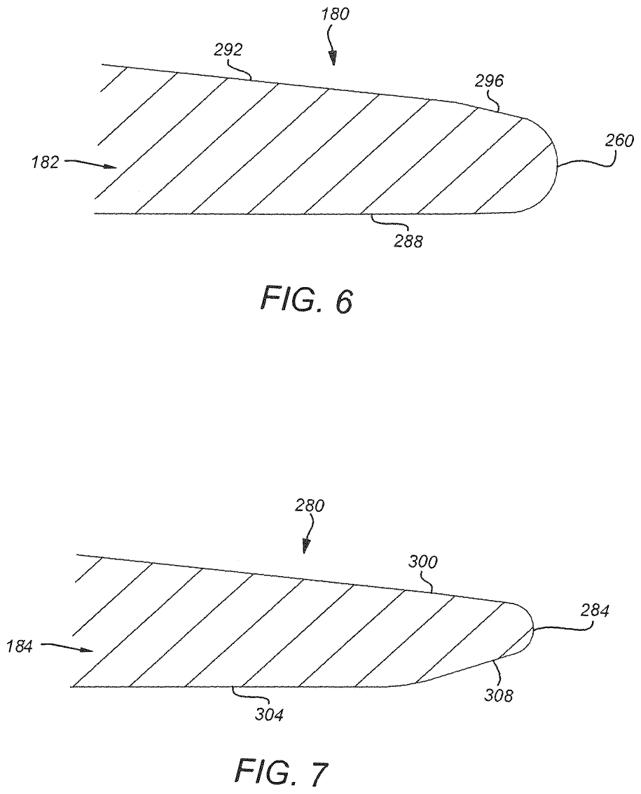

As shown in FIGS. 6, 7, and 8A, the cross-sectional views illustrate the buttressed or asymmetric construction of the main body 182 of the thread 180 and the top-biased portion 280 of the thread start 184. The main body 182 of the thread 180 (FIG. 6) includes a first surface 288 farthest from or distal relative to the opening 172, a second surface 292 closest to or proximal relative to the opening 172, which transitions into an angled surface 296 that is angled away from the opening 172, and a rounded crest 260 extending between the angled surface 296 and the first surface 288. As such, the rounded crest 260 of the main body 182 is generally centered with respect to the thread 180 and is angled slightly away from the opening 172 (FIG. 2) of the preform 160. The top-biased portion 280 of the thread start 184 (FIG. 7), includes a first surface 300 farthest from or distal relative to the opening 172, a second surface 304 closest to or proximal relative to the opening 172, which transitions into an angled surface 308 that is angled towards the opening 172, and a crest 284 extending between the first surface 300 and the angled surface 308. The crest 284 may be angled towards the opening 172 of the preform 160. In the illustrated embodiment, the crest 284 is offset at the thread start 184 such that a central portion of the crest 284 is positioned closer to the first surface 300 than to the second surface 304. In other words, the crest 284 of the top-biased portion 280 is positioned closer to the opening 172 than is the rounded crest 260 of the main body 182 of the thread 180.

As best shown in FIGS. 5 and 8A-8C, the threads 180 may further include a transition region 276 where the profile of the thread start 184 transitions to the profile of main body 182 of the thread 180. In some embodiments, such as the illustrated embodiment of FIG. 5, the transition region 276 may include a gap (FIG. 5) that separates a top-biased portion 280 of the thread start 184 from the main body 182 of the thread 180. In other embodiments, such as illustrated in FIGS. 8A-8C, the transition region 276 may be a continuous surface. In yet other embodiments, the transition region 276 may be formed as a stepped surface or another alternative construction. The construction of the transition region 276 may assist tooling during the manufacturing process of the threads 180. For example, a first tool may be used to form the main thread body 182 and a second tool may be used to form the thread start 184 and the transition region 276. In general, the top-biased portion 280 may include a profile that orients the top-biased portion 280 toward the opening 172. The two different profiles of the thread 180 therefore result in the start pitch 268 being greater than the thread pitch 272 disposed between the main body of the adjacent threads 180.

FIG. 9 illustrates an exemplary embodiment of a container closure 344 that may be threadably engaged with the finish portion 164 shown in FIG. 2. The illustrated embodiment of the closure 344 includes a closure portion 364 that is coupled with a tamper evidence band 348 by way of a multiplicity of thin connections 372. A plurality of knurls 376 may be arranged on top of the closure portion 364 and configured to facilitate grasping the closure portion 364 during tightening and untightening the closure 344 on the finish portion 164. Upon the closure portion 364 being untightened from the finish portion 164, the thin connections 372 break, allowing the tamper evidence band 348 to separate from the closure portion 364 and remain attached to the finish portion 164. As such, the tamper evidence band 348, once separated from the closure portion 364, provides an observational indication that the closure 344 has been unsealed from the finish portion 164 after having been installed by a manufacturer.

The closure 344 is configured to be threadably engaged with the finish portion 164 shown in FIG. 2. The closure 344 includes interior threads 380 and valleys that are configured to engage with the threads 180 and valleys 190 of the finish portion 164, as described herein. As such, the threads 380 extend into the valleys 190 extending around the finish portion 164. During tightening of the closure 344 onto the finish portion 164, a plug seal 384 of the closure 344 may extend into the opening 172 of the finish portion 164 and enter into a pressed relationship with the finish portion 164 whereby contents may be sealed in the interior of the container 100.

As mentioned above, the multiplicity of thin connections 372 may be configured to break apart when the closure portion 364 is untightened from the finish portion 164, such as during opening the container 100 to access contents within the container 100. As shown in FIG. 10, the tamper evidence band 348 includes a cam 388 that is configured to interfere with a flat lower portion 236 of the tamper evidence ledge 176 (see FIG. 4). The cam 388 generally comprises a ledge, or a similar structure, that extends around an inner circumference of the tamper evidence band 368 and is supported by a multiplicity of angled lower surfaces 396 configured to facilitate passing the tamper evidence band 368 over an upper rounded portion 232 (see FIG. 4) of the tamper evidence ledge 176 during installation of the closure 344 onto the container 100. As shown in FIG. 10, the cam 388 includes a relatively flat upper surface 404 that may be configured to interfere with the flat lower surface 236 (see FIGS. 2-3) of the tamper evidence ledge 176 and thus contributes to separating the tamper evidence band 368 and the closure portion 364 during loosening of the closure 344 on the finish portion 164.

In the illustrated embodiment, one or more of the threads 380 formed on the closure 344 have an asymmetric or buttressed construction. The closure 344 may engage with the finish portion 164 of the preform 160 described herein or a preform that includes a standard or uniform thread profile. In some embodiments, where closure 344 includes multiple threads 380 (e.g., three in the illustrated embodiment), one or more of the threads 380 may have an asymmetric or buttressed construction, while the remaining threads include a standard or uniform thread profile.

The closure 344 illustrated in FIGS. 9 and 10 includes thread starts 408 that are configured to guide the threads 380 of the closure 344 into the valleys 190 between the threads 180 of the finish portion 164. As best shown in FIG. 10, each of the threads 380 generally includes a rounded crest 412 joined with the sidewall of the closure portion 364 by way of concave flanks 416. The flanks 416 include a relatively uniform width along a majority of the length of the threads 380 (e.g., a main body of the thread 380). Along the thread start 408, however, the width of the flank 416 nearest the tamper evidence band 348 is narrower that the width of the flank 416 facing away from the tamper evidence band 348. As such, the thread start 408 is oriented, or biased, toward the tamper evidence band 348 of the closure 344, such that a start pitch 420 is disposed between the thread start 408 and the nearest neighboring thread 380. As best shown in FIG. 10, the start pitch 420 generally is greater than the thread pitch between adjacent threads 380.

In the illustrated embodiment of FIG. 10, the threads 380 and the thread starts 408 include crests 312 that are rounded and joined with adjacent concave flanks 316. In other embodiments, the threads 380 and the thread starts 408 need not be limited to rounded crests 412 or concave flanks 416. In some embodiments, for example, the thread starts 408 may be angled or skewed toward the tamper evidence band 348 or opening of the closure 344, while the main body of the threads are angled or skewed toward the plug seal 384. Angling or skewing the thread starts 408 toward the tamper evidence band 348 provides a start pitch 420 that is greater than the thread pitch between the threads 380. In some embodiments, the threads 380 of the closure 344 may have a similar buttressed construction as the threads 180 of the preform 160, described in detail above with respect to FIGS. 6-8C.

As previously described, the disclosed embodiments related to the threads 180 of the preform 160 are equally applicable to the threads 180 of the closure 144, and vice versa, and any features herein disclosed of any one thread or any plurality of threads 180 may be applied to the finish portion 164 or the closure 144 for cooperation therebetween.

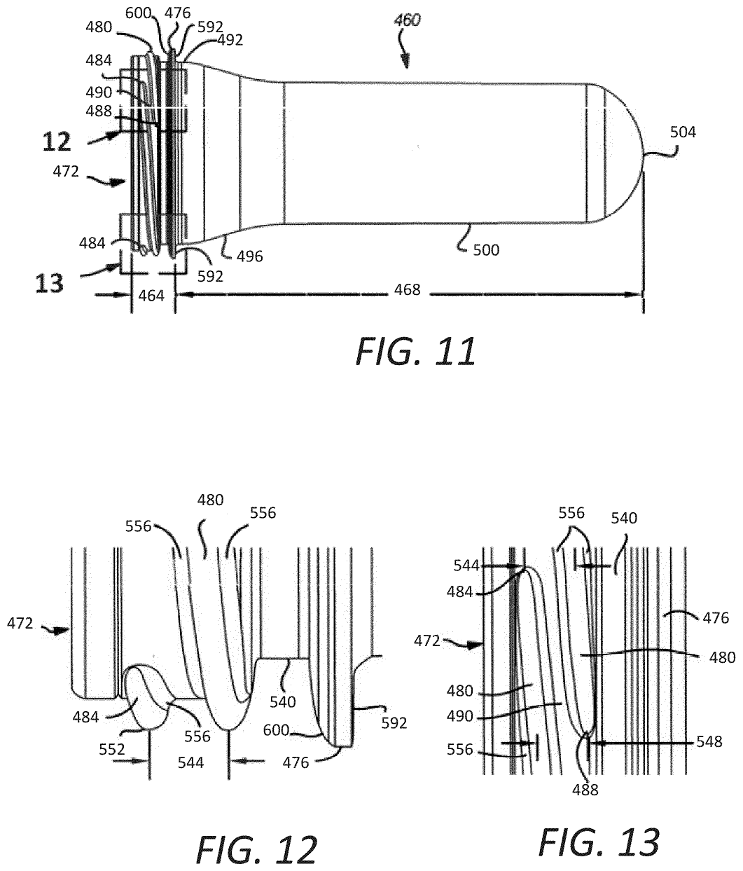

FIGS. 11-13 illustrate a preform 460 suitable for being blow-molded to form a plastic bottle, such as the container 100, according to another embodiment of the present disclosure. The preform 460 is similar to the preform 160 shown in FIG. 1-7 and described above. Therefore, like features are identified with like reference numerals plus “300”, and only the differences between the two will be discussed.

The preform 460 includes a finish portion 464 and a body portion 468, formed monolithically (i.e., as a single, or unitary, structure). The finish portion 464 begins at an opening 472 to an interior of the preform 460 and extends to and includes a tamper evidence ledge 476. Each of the threads 480 generally extends along a section of the circumference of the finish portion 464 and approaches the tamper evidence ledge 476. Each of the one or more threads 480 begins at a thread start 484 and extends along an angular section of the finish portion 464 to a thread end 488. The thread start 484 is configured to guide a thread comprising the closure 444 into a space, or a valley 490, between adjacent threads 480 so as to threadably engage a closure with the finish portion 464. Further, the threads 480 generally are disposed adjacently to one another, separated by valleys 490, and are spaced uniformly around the circumference of the finish portion 464. In some embodiments, the finish portion 464 includes three threads 480 are disposed around the finish portion 464, the thread starts 484 of adjacent threads 480 are spaced at substantially 120-degree intervals around the perimeter of the finish portion 464. In the illustrated embodiment, the thread end 488 is offset the thread start 484 of the adjacent thread 480.

As best shown in FIG. 12, each of the threads 480 generally includes a rounded crest 552 joined with the sidewall of the finish portion 464 by way of concave flanks 556. The flanks 556 include a relatively uniform width along a majority of the length of the threads 480. Along the thread start 484, however, the width of the flank 556 nearest the opening 472 is narrower that the width of the flank 556 facing away from the opening 472. As such, the thread start 484 is oriented, or biased, toward the opening 472 of the preform 460, such that a start pitch 544 is disposed between the thread start 484 and the nearest neighboring thread 480. As best shown in FIGS. 12 and 13, the start pitch 544 generally is greater than a thread pitch 548 disposed between adjacent threads 480.

The threads 480 and the thread start 484 includes crests 552 that are rounded and joined with adjacent concave flanks 556. In the illustrated embodiment, the crests 552 are generally uniform along the entire length of the threads 480, while the concave flanks 556 are vary. As such, the change in the dimension of the concave flanks 556 angles the thread starts 484 towards the opening 472, while the main body of the threads 480 are angled away from the opening 472. Angling the thread starts 484 toward the opening 472 provides a start pitch 544 that is greater than the thread pitch 548 between the threads 480.

While the disclosure has been described in terms of particular variations and illustrative figures, those of ordinary skill in the art will recognize that the disclosure is not limited to the variations or figures described. In addition, where methods and steps described above indicate certain events occurring in certain order, those of ordinary skill in the art will recognize that the ordering of certain steps may be modified and that such modifications are in accordance with the variations herein. Additionally, certain of the steps may be performed concurrently in a parallel process when possible, as well as performed sequentially as described above. To the extent there are variations that are within the spirit of the disclosure or equivalent to claimed features, it is the intent that this patent will cover those variations as well. Therefore, the present disclosure is to be understood as not limited by the specific embodiments described herein, but only by scope of the appended claims.

What is claimed is:

1. A container preform for forming a plastic container, the preform comprising:
a neck with a finish portion including an opening; and
one or more threads disposed on the finish portion for rotatably engaging with a closure to seal contents within an interior of a container formed from the preform, wherein at least one of the one or more threads includes
a main thread body, and
a thread start configured to guide a thread of the closure into engagement with the main thread body, the thread start being biased towards the opening.

2. The preform of claim 1, wherein a first thread pitch between the thread start and an adjacent thread is greater than a second thread pitch between the main thread body and the adjacent thread.

3. The preform of claim 1, wherein the main thread body is skewed away from the opening.

4. The preform of claim 1, wherein the main thread body includes a first profile and the thread start includes a second profile that is different than the first profile.

5. The preform of claim 4, further comprising a transition region extending between the main thread body and the thread start to transition the first profile of the main thread body to the second profile of the thread start.

6. The preform of claim 1, wherein the at least one of the one or more threads includes a rounded crest joined with a sidewall of the finish portion by way of concave flanks.

7. The preform of claim 6, wherein each of the concave flanks has a uniform width along the main thread body.

8. The preform of claim 6, wherein the thread start includes a flank width proximal the opening that is narrower than an opposing flank width distal from the opening.

9. The preform of claim 1, wherein at least one of the thread start or the main thread body includes a cross-sectional contour having a first surface, a second surface, a planar angled surface transitioning from one of the first or second surfaces, and a crest extending between the other one of the first or second surface and the planar angled surface.

10. The preform of claim 9, wherein the crest of the thread start is positioned closer to the opening than the crest of the main thread body.

11. A finish portion assembly of a container preform for forming a plastic container, the finish portion assembly comprising:
a neck with a finish portion having an opening and including a first set of threads; and
a closure including a second set of threads for engaging with the first set of threads to seal contents within an interior of a container formed from the preform, wherein at least one thread of one of the first or second set of threads includes:
a main thread body, and
a thread start configured to guide the other of the first or second set of threads into engagement with the one of the first or second set of threads,
wherein a first thread pitch between the thread start and an adjacent thread is greater than a second thread pitch between the main thread body and the adjacent thread.

12. The finish portion assembly of claim 11, wherein the thread start of the first set of threads is biased towards the opening.

13. The finish portion assembly of claim 12, wherein the thread start of the second set of threads is biased away from the opening.

14. The finish portion assembly of claim 11, wherein the first set of threads includes a rounded crest joined with a sidewall of the finish portion by way of a first pair of opposing flanks and the second set of threads includes a rounded crest joined with a sidewall of the closure by way of a second pair of opposing flanks, and wherein with respect to at least one of the first pair of opposing flanks and the second pair of opposing flanks, a flank width of one flank of the opposing flanks is narrower than a flank width of the other flank of the opposing flanks.

15. A finish portion of a container preform for forming a plastic container, the finish portion comprising:
one or more threads disposed on the finish portion for rotatably engaging with a closure, wherein at least one of the one or more threads includes
a main thread body having a first profile, and
a thread start configured to guide a thread of the closure into engagement with the main thread body, the thread start having a second profile that is different than the first profile.

16. The finish portion of claim 17, further comprising a transition region extending between the main thread body and the thread start to transition the first profile of the main thread body to the second profile of the thread start.

17. The finish portion of claim 17, wherein finish portion includes an opening, and wherein the thread start is biased towards the opening.

18. The finish portion of claim 17, wherein a first thread pitch between the thread start and an adjacent thread is greater than a second thread pitch between the main thread body of the adjacent thread.

19. The finish portion of claim 17, wherein the first profile is defined as a cross-sectional contour of the main thread body in a first circumferential position normal to the finish portion and the second profile is defined as a cross-sectional contour of the thread start in a second circumferential position normal to the finish portion.

20. The finish portion of claim 17, wherein at least one of the first profile or the second profile includes a first surface, a second surface, a planar angled surface transitioning from one of the first or second surfaces, and a crest extending between the other one of the first or second surface and the planar angled surface.
